(19) United States
(12) Patent Application Publication
(10) Pub. No.: US 2002/0116201 A1
(43) Pub. Date: Aug. 22, 2002

(54) Millennium connection

(76) Inventor: Najeeb Mohammad Nasim, Corona, CA (US)

Correspondence Address: NAJEEB MOHAMMAD NASIM, 1023 La Vaughn Circle, Corona, CA, 92881, US

(21) Appl. No.: 09/788,020

(22) Filed: Feb. 20, 2001

(51) Int. Cl. G06F 17/60

(52) U.S. Cl. 705/1

(57) ABSTRACT

The idea of this invention is to find people the man/woman of their dreams exact to their description send them to an exotic vocation of their choice with that person and give them a chance to make a lot of money in the process by referring other customers to the company and signing them up as a client.

### BACKGROUND OF THE INVENTION/BRIEF SUMMARY

The reasons behind this invention are most of the divorced people in our community are the people that was not happy with their partners because they made an exception. Instead of finding the man/woman of their dreams, they found some one who wasn't exactly what they were looking for, made an exception and married that person. After a few months or years they found out that they are not happy with the person, or that person doesn't have any thing in common with him/her. It is hard in our time consuming society to spend time and find the man/woman of your dreams. Most of single people have the hardest time finding what they are looking for, some of them giving up the idea of looking for the man/woman of their dream it is to time consuming and it take a lots of energy and patients. Almost every one we meet we have to spend a lot of time gathering information from them to see if they meet our personal needs and desires. A lot of time people get tired of dating and they make exception and go through life with a person who they are not even attracted to. That's why there are so many single parents and divorced couple around us.

I am a complete believer that this invention will bring the divorce percentage lower in the United States and people will have better attitudes and live happier lives because they are with some one who they are attracted to physically and mentally.

### SPECIFICATION

This invention was created for people who want to find the man/woman of their dreams. The way it works is the customer goes to the company's web site and goes through a series of questions about what he/she is looking for in a partner, customer can choose their height, weight, ethnic background, color of hair, hobbies, favorite food, favorite music, etc. The company would match customer's description to the company's database and match them up with some one exactly like their description. The customer would view the client's portfolio and photos and make their selections. After the selection process is complete customer would be set up on a date with all the clients he/she choose. After the dating cycle is complete the customer and one of the chosen clients would be treated to 5 days 6 night vocation of their choice from company's available exotic vacation spots in the world.

The customer also would have a chance to make money in the process if he/she chooses to join the company's referral program by referring customers to the company and signing them up as a client.

### DESCRIPTION OF THE INVENTION

This invention is an idea for business, it an idea to help people of all ages find the man/woman of their dreams, give them a chance to select from hundreds of people and choose the perfect one for themselves, go on a dream vacation with that person and make money in the process by joining the referral program. Here is how it works:

### PART ONE

The idea of this invention is to get information from people about what they are looking for in a person, for example age, height, weight, color of hair, favorite music, favorite food, favorite sports, hobbies and life style, etc. This would make it easier to categorize clients. Once all the clients are categorized, it would be easier to match them up with other clients. The way the clients would make their selection is by going to the company's website and going through the series of questions about what he/she is looking for in a person. After the customer inputs all the information regarding what they are looking for in a person, the computer would match their selections to the company's files and pull information on all the clients that matched the customer description. After the matching process is complete the customer would have a chance to view the pictures of all the clients that matched his/her description to see what they look like, after viewing the pictures the customer would have to choose minimum of 3 to maximum of 10 clients that he/she like the most. The clients that were chosen by the customer would have a chance to view the customer's portfolio and picture to see if they would like to be set up on a date with the him/her. If whoever many of the clients choose the customer they would be set up on a date so they can get to know each other better. After the dating process is complete the customer and one of the client that was chosen would be treated to 5 days 6 nights vacation of their choice from the company's available exotic vacation spots in the world.

### PART TWO

All the customers that join the company would have a chance to make money in the process by joining the referral program. The way it works is by referring customers to the company and signing them up as a client. For every referral that a client refers to the company and they sign up the client would receive $10.00, also for every customer that your referral signs up with the company the you would receive $5.00 down to referral #6.

### FOR EXAMPLE

1^{st} client that you sign up with the company you will receive $10.00 per month.

1^{st} customer that your client signs up with the company you would receive $5.00 per month.

1^{st} customer that your client's customer signs up with the company you would receive $5.00 per month.

2^{nd} customer that your client's customer signs up you would receive $5.00 per month.

3^{rd} customer that your client's customer signs up you would receive $5.00 per month.

4^{th} customer that your client's customer signs up you would receive $5.00 per month.

For total of 5 customers that signed up under the first client for total of 6 clients. For total income of $35.00 per month.

If you sign up only 25 different clients and your clients sign up 6 customers apiece your income would be 25×6=150 clients×$35=$875.00 per month.

If you sign up 50 different clients to the company and every single one of your clients sign up 50 customers a piece your monthly income would be 50×6=350 clients×$35=$12250.00 per month.

The more clients you sign up with the company the more money you would make, the more people under you sign up the more money you would make.

All of these services are for a small fee of $39.95 per month if you decide not to join the referral program or $59.95 if clients decide to join the referral program for minimum period of 12 months. If a client chooses to receive money from clients under them after the 12 months period, they need to continue making payments to the company even after the 12-month period. As long as the customers keeps their account current with the company by making their payments on time, they would receive money for every single one of those clients under them for as long as they are alive.

1. What I claim as my invention is giving people an opportunity to live happier lives with some one who they are attracted to and feel comfortable with. I think this invention is something we need in our time consuming society, so we all can live better our children will have better parenthood and our way of life would get better. This is defiantly not the answer to every relationship problems but it is a very good start.

2. What I claim as my invention is giving people an opportunity to meet the man/woman of their dreams exact to their description, make money and have fun in the process. I am a believer if people are happy in their relationships they would become successful in their jobs and become good providers for society. This is a great opportunity to live happier life with the person of your dreams, be a great parent to your children's, have fun in life and make money in the process by joining the referral program.
